(19) United States
(12) Patent Application Publication
(10) Pub. No.: US 2013/0054854 A1
(43) Pub. Date: Feb. 28, 2013

(54) Full Bus Transaction Level Modeling Approach for Fast and Accurate Contention Analysis

(71) Applicants: Mao-Lin Li, Hsinchu (TW); Chen-Kang Lo, Hsinchu (TW); Li-Chun Chen, Hsinchu (TW); Hong-Jie Huang, Hsinchu (TW); Jen-Chieh Yeh, Hsinchu (TW); Ren-Song Tsay, Hsinchu (TW)

(72) Inventors: Mao-Lin Li, Hsinchu (TW); Chen-Kang Lo, Hsinchu (TW); Li-Chun Chen, Hsinchu (TW); Hong-Jie Huang, Hsinchu (TW); Jen-Chieh Yeh, Hsinchu (TW); Ren-Song Tsay, Hsinchu (TW)

(73) Assignee: NATIONAL TSING HUA UNIVERSITY, Hsin Chu City (TW)

(21) Appl. No.: 13/398,083

(22) Filed: Feb. 16, 2012

(30) Foreign Application Priority Data
Aug. 25, 2011 (TW) 100130541

(51) Int. Cl. G06F 13/362

(52) U.S. Cl. 710/110

(57) ABSTRACT

The present invention presents an effective Cycle-count Accurate Transaction level (CCA-TLM) full bus modeling and simulation technique. Using the two-phase arbiter and master-slave models, an FSM-based Composite Master-Slave-pair and Arbiter Transaction (CMSAT) model is proposed for efficient and accurate dynamic simulations. This approach is particularly effective for bus architecture exploration and contention analysis of complex Multi-Processor System-on-Chip (MPSoC) designs.

### FIELD OF THE INVENTION

The present invention relates a simulation method, and more specifically to a full bus transaction level modeling approach for fast and accurate contention analysis.

### BACKGROUND OF THE INVENTION

As the design complexity of SoC grows, hardware/software (HW/SW) co-simulation becomes more and more crucial for early-stage system verification. To simplify the simulation efforts on register transfer level (RTL) designs, the concept of transaction-level modeling (TLM) for hardware was introduced. By adopting higher abstraction modeling, hardware simulation can be greatly accelerated while key operational information is maintained at the same time. Nevertheless, software is an essential system component, and it also requires proper abstraction models to be compatible with hardware TLM models for efficient HW/SW co-simulation. In particular, it is showed that the complexity of embedded software is rising 140 percent per year, which is greater than that of hardware at 56 percent per year. Obviously, abstraction for software is an urgent subject for investigation, and therefore some conventional approaches have developed in recent years.

Transaction-level modeling (TLM) is formally defined as a high-level approach to model digital systems where the communication among modules is separated from the functional units. A conventional approach integrates an ISS and SystemC. To enable the communication between the two different simulators, the conventional approach employed a bus functional model as a bridge. However, the ISS is quite slow (few MIPS only), and the expensive communication cost further downgrades the simulation speed.

Due to the relentless demands for high-performance computation and low power consumption in embedded systems, multi-processor system-on-chip (MPSoC) has become the mainstream design approach. For MPSoC design, one of the most critical issues is the on-chip communication design (e.g., shared bus, bus matrix) because of the multiplied data exchange rate among the large number of components. As design complexity continues to increase, having an efficient and effective tool for extensive bus architecture exploration is indispensible before committing a design to real hardware.

For communication architecture exploration, designers are particularly interested in the rate of bus contentions and the effectiveness of contention handling. In practice, an arbiter is used to resolve contentions and determine transaction execution order according to certain arbitration policy, such as the round-robin or fixed priority policy. Contentions cause certain transactions to change or defer their execution order. Hence, accurate contention analysis is essential for performance evaluation during exploration.

To alleviate time-to-market pressure, designers demand contention analysis, correctness verification, and performance estimates by system simulation at early design stages. However, the complexity of traditional RTL simulation approaches makes these procedures prohibitively difficult. The transaction-level modeling (TLM) approach, which raises the abstraction level to speed up simulation performance, has been proposed as a solution (please refer to: L. Cai, D. Gash. “Transaction Level Modeling: An Overview,” in CODES+ISSS, October 2003).

Moreover, to accurately simulate bus behaviors, traditional TLM bus modeling approaches adopt fine-grained models, such as cycle-accurate (CA) models, which simulate arbitration behaviors cycle by cycle. The heavy simulation overhead associated with these fine-grained approaches for handling the interactions between bus transactions and the arbiter limits the practicality of such approaches.

In contrast, for better performance, some researchers embrace coarse-grained modeling approaches, such as functional-level or cycle-approximate modeling. However, these approaches can be misleading when used for exploration purposes when arbitration information is inaccurate or missing. Moreover, designers generate these models manually in practice and the manual generation procedure is known to be tedious and error-prone.

Although various TLM bus models have been proposed, none can accurately perform arbitration analysis with efficiency. The main challenge is that the arbitration behaviors are irregular and unpredictable due to complicated combinations of requests and arbitration policy. To address such issues, the present invention a full bus transaction level modeling approach for fast and accurate contention analysis.

### SUMMARY OF THE INVENTION

To address the above issues, the present invention provides a two-phase bus modeling to simply procedures of arbitration and bus transaction.

One advantage of the present invention is to utilize the repetition property to pre-analyze the arbitration procedure without cycle-by-cycle simulation and guarantee the correct transaction execution order during simulation, and thereby improving simulation performance significant.

The present invention proposes a method of a full bus transaction level modeling for fast and accurate contention analysis, comprising: for each master, computing a request and inserting the request into a request queue by a processing unit until the request queue is empty. Next, if no active request is in the request queue, advancing an arbiter time to a request time of an earliest future request. Otherwise, selecting and granting an active request based-on a given arbitration policy is performed. Subsequently, computing a request phase execution time of the active request by the processing unit is performed. In the following, computing a grant phase execution time of the active request by the processing unit. Finally, it is examining a requesting master and/or an accessed slave of the granted request, if any of them will generate a new request, push the new request into the request queue.

The computing a grant phase execution time of the active request is performed according to a CMSAT model of the active request. CMSAT model is that once a transaction enters into the grant phase, it cannot be preempted and no other transactions on the same bus can enter the grant phase until it returns to the request phase again. After the request is granted for bus transaction, remainder requests stay in the queue and the granted request will start bus transaction until completion.

A method of a full bus transaction level modeling for fast and accurate contention analysis, comprising: receiving bus requests from master components by an arbiter and then performing an arbitration process and granting according to a specified arbitration policy. Then, in a request phase, the arbiter collects all incoming request signals and computes which master component is granted. Next, in a grant phase, the arbiter assigns the granted master component to have the bus for data transfer. Finally, it is sending a notification signal by a processing unit to the arbiter such that the arbiter returns to its initial state and gets ready for a next request processing.

The performing an arbitration process is accomplished by asserting specific handshake signals.

The method further comprises a step of modeling accessible slaves identified by memory-mapped address from the granted master component. Each slave component has its corresponding multiplexer controlled by the arbiter, and each master component has its corresponding demultiplexer.

The method further comprises a step of modeling potential accessing master components. If no request tends to use the bus, the arbiter stays in an initial state.

To further understand technical contents and methods of the present invention, please refer to the following detailed description and drawings related the present invention.

### BRIEF DESCRIPTION OF THE DRAWINGS

The invention is more fully appreciated in connection with the following detailed description taken in conjunction with the accompanying drawings; however, those skilled in the art will appreciate that these examples are not intended to limit the scope of the present invention, and various changes and modifications are possible within the sprit and scope of the present invention.

FIG. 1 shows an example of write transaction described by FSMs.

FIG. 2 shows an example of an arbiter FSM which adopts a fixed priority arbitration policy.

FIG. 3 shows a generic bus model for a two-master two-slave example.

FIG. 4a shows a compressed write transaction model of the master-slave pair.

FIG. 4b shows a two-phase arbiter model.

FIG. 4c shows a CMSAT model.

FIG. 5 shows an example of a dynamic simulation.

FIG. 6 shows the PAC-Duo platform according to the proposed formal definition.

FIG. 7 shows the results of total throughputs of the platform with four different arbitration policies.

### DETAILED DESCRIPTION OF THE PREFERRED EMBODIMENT

The present invention and embodiments are now described in detail. In the diagrams and descriptions below, the same symbols are utilized to represent the same or similar elements. The possible embodiments of the present invention are described in illustrations. Additionally, all elements of the drawings are not depicted in proportional sizes but in relative sizes.

In MPSoC designs, it is common to have multiple bus requests contending for bus access at the same time. To resolve contention, an arbiter is implemented to perform arbitration. When arbitration is received external requests, it therefore determines which request is granted to use bus based-on the designed arbitration strategy.

To effectively and accurately capture the timing behaviors of arbitration, the present invention proposes a two-phase bus model to abstract the procedure of arbitration and bus transactions in this paper. The arbitration is a dynamic handshaking process that can be split into request phase and grant phase according to the specific handshake signals controlling arbitration. Since the request phase and the grant phase alternate repeatedly and synchronously with bus transactions, it can utilize the repetition property to pre-analyze the arbitration procedure without cycle-by-cycle simulation and guarantee the correct transaction execution order during simulation.

The present invention presents an effective Cycle-count Accurate Transaction level full bus modeling (CCA-TLM) and simulation technique. Using the two-phase arbiter and master-slave models, an FSM-based Composite Master-Slave-pair and Arbiter Transaction (CMSAT) model is proposed for efficient and accurate dynamic simulations.

The approach of the present invention is particularly effective for bus architecture exploration and contention analysis of complex Multi-Processor System-on-Chip (MPSoC) designs.

A generic bus model involves multiple components (e.g., masters, slaves and arbiters). In MPSoC designs, it is common to have multiple bus requests contending for bus access at the same time. To resolve contention, an arbiter is implemented to perform arbitration. When arbitration is considered, the bus behavior becomes fairly complicated.

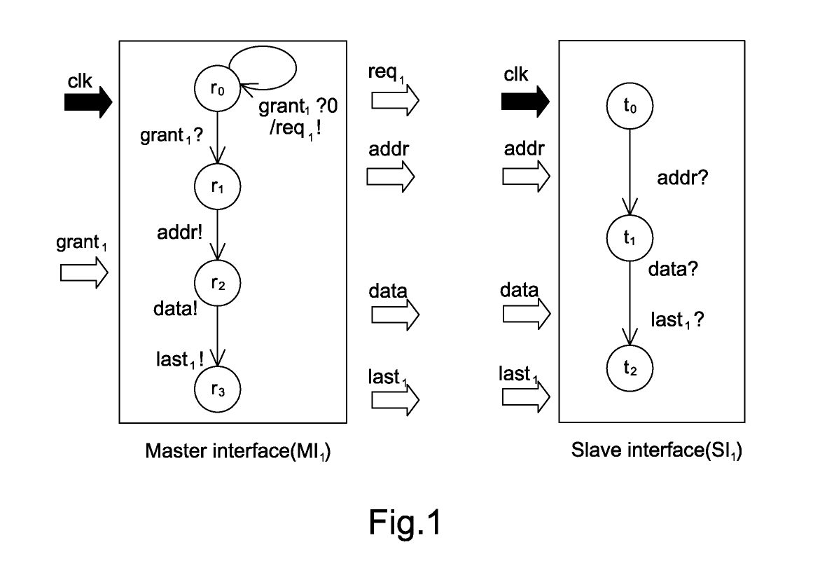

Before formally specifying the FSM-based communication interface model, FIG. 1 is first illustrated in a simple example to familiarize readers with basic FSM operations. The example shows a master and a slave interfaces described in FSMs performing a write transaction.

As shown in FIG. 1, the master and slave interfaces begin synchronously from state r₀ and state t₀, respectively. Initially, the master interface MI₁ is not granted, and it sends out the signal req₁ to request bus usage, denoted as reg₁!1. Once MI₁ receives a grant signal to use bus, denoted as grant₁?1, it progresses its state from r₀ to r₁. Then, MI₁ emits addr (for data address, denoted as “addr!”) to the engaged slave interface, and progresses the state transition from r₁ to r₂. Simultaneously, the engaged slave interface SI₁ receives the signal addr, denoted as “addr?”, and then progresses its state from t₀ to t₁. This process continues until the state progress reaches the final states r₃ and t₂. At this point, the write transaction is completed.

Although communication interfaces are more than read/write operations, in practice read and write data transfers are the most basic communication behaviors. To describe a general and formal communication interface model, it modify the syntax of the reference document (V. D'silva, S. Ramesh, and A. Sowmya, “Synchronous Protocol Automata: A Framework for Modeling and Verification of SoC Communication Architecture”, in DATE, 2004) and propose a definition 1 in the following.

Definition 1: A Finite State Machine (FSM)-based communication interface model is a tuple (Q, Input, Output, C/O, V, →, clk, q₀, q_{f}), where
1. Q: a finite set of states
2. Input: a set of input data and control signals
3. Output: a set of output data and control signals
4. C/O: condition/operation
5. V: a set of internal variables
6. →Q×Q×C/O×clk?: transition relations
7. q₀, q_{f} Q: the initial state and the final state

According to the above definition 1, the FSM for each communication interface has certain specified input and output signals and performs transitions between states listed in a set Q. The state transition in each FSM starts from the initial state q₀ and ends at the final state q_{f}. Every clk tick triggers a state progress. The operation O is a set of signal operations. For example, the action “s!” denotes that the signal s is emitted from the interface, and “s?” denotes that the signal s is read by the interface. C/O on each state progress edge indicates that once the condition C is met, the corresponding operation O will be issued. The condition C is checked against with the value of the internal variables in V (e.g., the counter in burst transfer) or specific input signals (e.g., last).

The above formal communication interface model describes only how one component communicates with others. In the next section, the idea is to extend and explain how to model a generic bus.

Like the formal communication interface model, the arbitration process can be described as an FSM. In general, the arbiter receives bus requests from master components and then arbitrates and grants bus access to one of the requests according to a designer-specified arbitration policy. The above arbitration procedure is accomplished by asserting specific handshake signals. Hence, we further divide the arbitration procedure into two phases, Request phase (R) and Grant phase (G), according to handshake signals that control arbitration. Transitions with incoming request signals and their descendants before having grant signals are included in the Request phase, while the remaining transitions, starting from those of grant signal assertions until transaction finish notification from master-slave pair, are in the Grant phase. It indicates a request phase that prior to the arbiter receives the external IP requests for using bus resource. Essentially, at the Request phase the arbiter receives external requests and selects a master-slave pair for bus transaction while at the Grant phase the granted master-slave pair executes the transaction.

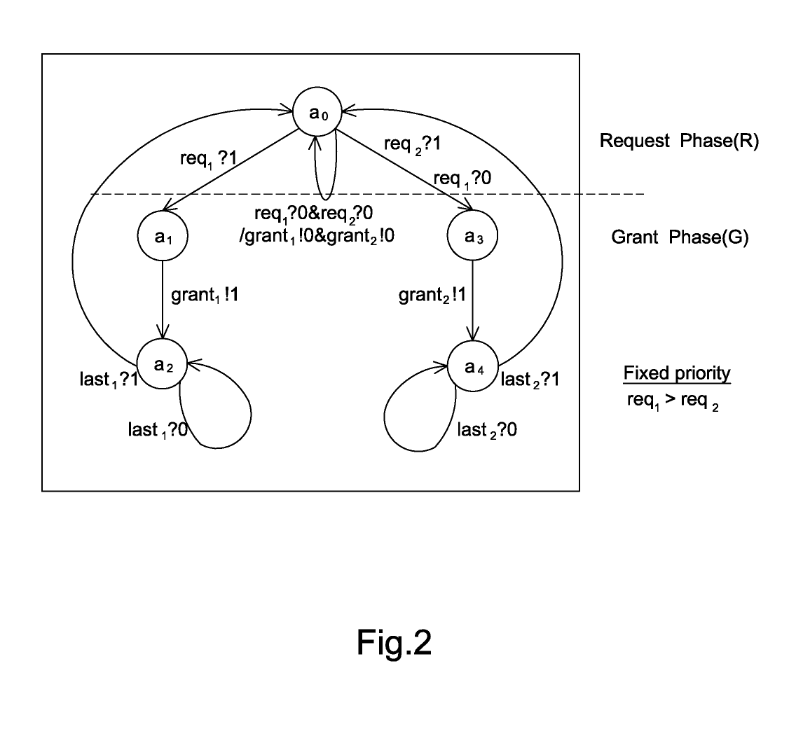

The example in FIG. 2 illustrates an arbiter FSM which adopts a fixed priority arbitration policy. It assumes that the request req1 from MI₁ has higher priority than req₂ and the fact is reflected in the arbiter FSM.

It is first explained how the request and grant procedures work. In example FIG. 2, the state of arbiter will be a₀ initially. The annotation “req₁?1” on the state transition edge from a₀ to a₁ indicates that the arbiter receives a bus request from MI₁. Similarly, “req₂?1, req₁?0” on the transition from a₀ to a₃ indicates that the request from MI₂ is asserted while MI₁ has no request. In general, in the Request phase, the arbiter collects all incoming request signals and computes which master is granted.

After the Request phase, a master is selected and then the arbiter moves to Grant phase and assigns the master to have the bus for data transfer. In FIG. 2, when req₁ is asserted, according to the arbitration policy the request from MI₁ has the priority and hence the arbiter asserts grant₁, or “grant₁!1”, and grants MI₁ to start its data transfer. The above state transition sequence is denoted in shorthand as a₁→a₂.

After MI₁ finishes its transaction, it sends a notification signal, last₁ to the arbiter, denoted as “last₁?1”, and has the arbiter return to its initial state a₀ and get ready for next request processing.

If only req₂ from MI₂ is asserted and req₁ is absent, the arbiter will grant MI₂ for data transfer and the granting process is similar to what have been described for MI₁. Furthermore, if no request tends to use the bus, the arbiter stays in the initial state a₀.

After the Grant phase is completed, the arbiter returns to the Request phase. The two phases alternate repeatedly throughout the system active period for bus transactions. In fact, an arbiter functions exactly as a scheduler. It collects issued requests and grants one for execution according to the arbitration policy designed in terms of the arbiter FSM.

One key point is that with the proposed two-phase arbiter model, the state progression of an arbiter can be greatly simplified without losing functionality or timing correctness. It will elaborate on this after a formal model for generic buses is defined.

After adding the arbiter model along with the master and slave models, a generic bus now can be defined as the following.

Definition 2: An FSM-based bus model is a four-tuple (M, S, A, I), where
1. M: a set of master interfaces described by FSM;
2. S: a set of slave interfaces described by FSM;
3. A: a set of arbiters described by FSM;
4. I: the interconnection among master/slave interfaces and arbiters;

The interconnection I describes the connectivity relationship among diverse interfaces without specific direction. Since most bus protocols use a memory map to designate slave components on the bus, here it assumes the same memory map practice. A demux (demultiplexer) 23, 24 is used to model the accessible slaves identified by the memory-mapped address from a master. Similarly, a mux (multiplexer) 21, 22 is used to model for a slave the potential accessing masters and the controlling arbiter 20 as described in the following. For example, the multiplexer 21, 22 are connected to the arbiter 20.

.demux(mⱼ, sⱼ₁, . . . ,sⱼₖ, mⱼ.addr)
The master interface mⱼ can access slave interfaces sⱼ₁ . . . sⱼₖ, and the memory mapped address determines which slave to be accessed.
.mux(mᵢ₁, . . . ,mᵢₖ, sᵢ, arbiter)
The slave interface sᵢ can receive access requests from master interfaces mᵢ₁ . . . mᵢₖ and then the arbiter decides which request is to be granted.

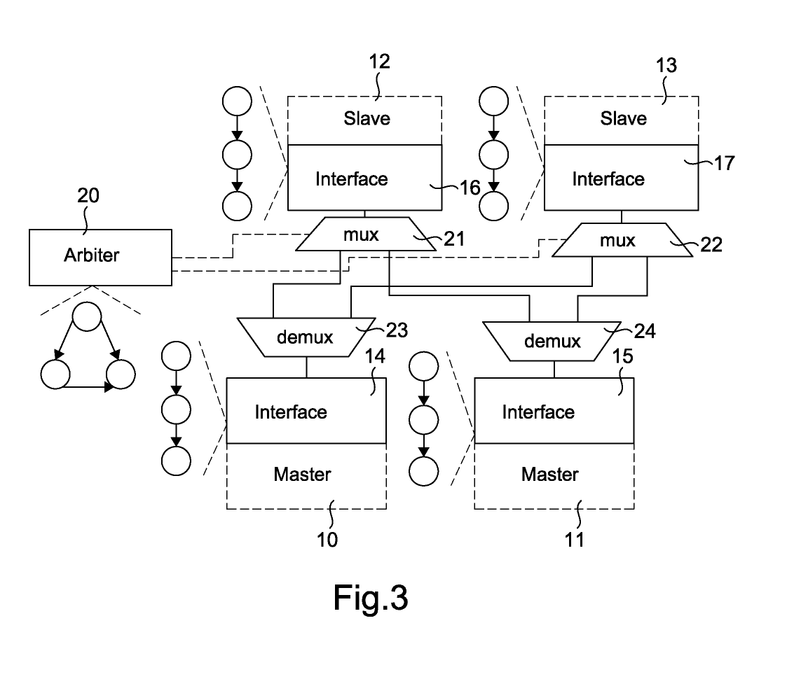

A generic bus model for a two-master two-slave example is illustrated in FIG. 3. Each of the two masters (master 10 and master 11) has its own demux (23, 24) representing the interconnection with the available slaves. demux is connected to mux. In addition, each slave (slave 12 or slave 13) has its corresponding mux (21, 22) controlled by a central arbiter 20. The masters 10, 11 and the slaves 12, 13 are connected to interfaces 14, 15 of the master and interfaces 16, 17 of the slaves, respectively. The interfaces 14, 15 of the master are connected to the demux 23, 24. The interfaces 16, 17 of the slaves are connected to the mux 21, 22, respectively.

Accordingly, the complete bus model of the example in FIG. 3 is listed below.

### Bus=(M, S, A, I)

M={m1, m2}; // the interfaces of master1 and master2
S={s1, s2}; // the interfaces of slave1 and slave2
A={A1}; // the FSM of arbiter
I={demux(m1, s1, s2, m1.addr), demux(m2, s1, s2, m2.addr), mux(m1, m2, s1, A1), mux(m1, m2, s2, A1)};
II the bus that m1, m2, s1 and s2 are connected to shares a central arbiter A1.

With the formal generic bus model, a static model abstraction and dynamic simulation algorithm are proposed in the followings for leveraging the two-phase arbiter model. Such approach can achieve fast and accurate full bus simulation.

In the following, the main idea is further elaborated to demonstrate the effectiveness of the present invention's approach. The approach has two steps: static model abstraction and dynamic simulation. At the static phase, the behaviors of bus transactions and arbitration process are analyzed and abstract models are created by optimizing routine simulation procedures. Then at the dynamic simulation phase, with the interacting signals and actual data, accurate arbitration and bus transaction results are computed.

The concept of static model abstraction is then explained below.

The basic bus function is essentially data transfer, or data read/write, between masters and slaves. In the present invention, Lo's compression approach is adopted and extended for model abstraction of the master/slave transaction pair with accurate cycle count information retained (refer to : C. K. Lo, R. S. Tsay, “Automatic Generation of Cycle Accurate and Cycle Count Accurate Transaction Level Bus Models from a Formal Model,” in ASP-DAC, 2009).

Basically, the compression algorithm analyzes the FSM-pair of master/slave interfaces and merging them into one FSM that represents the behavior of bus transaction. The compressed FSM eliminates confirmed internal handshaking signals between master and slave interfaces and reduces unnecessary simulation overhead with fewer transition steps while maintaining same cycle count information as the CA model. On the other hand, the external interacting signals are preserved, such as the handshaking signals req, grant and last, which interact with the arbiter for accurate dynamic behavior simulation.

Based-on behaviors between the master/slave interfaces and the arbiter described by using FSM, it can be realized that a full TLM bus model is employed by a numerous concurrent FSMs processing to complete data transmission.

Main object of CMSAT is compressed the master/slave interfaces FSM such that handshaking signals between the master/slave interfaces are reduced to obtain accurate cycle count of accomplishing bus transaction. To represent an accurate result of arbitration, the handshaking signals with the arbiter are preserved in bus transaction. Subsequently, the proposed two-phase arbiter model is combined to create the present invention's CMSAT model. CMSAT model may stand for the accomplishing action and the required cycle time for entering a corresponding grant phase after an arbiter receiving a request in a request phase.

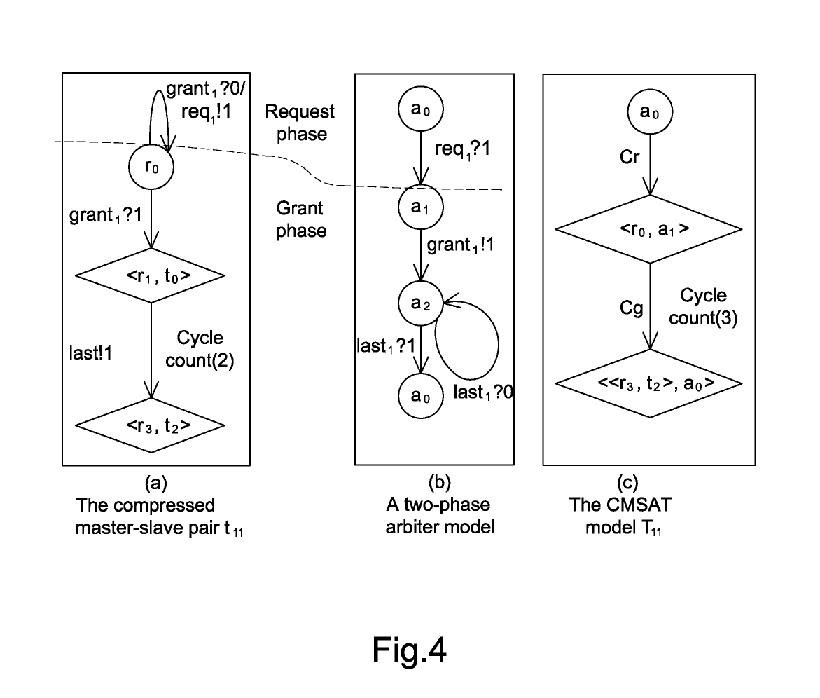

The FSM shown in FIG. 4(a) is the compressed write transaction model of the master-slave pair discussed in FIG. 1. The address and data transfers are compressed into one state transition step with a computed cycle count equivalent to the actual number of cycles taken. Note that each rhombus in the compressed model denotes a composite FSM node.

With the compressed bus model, once the issued bus transaction is granted during simulation, the cycle count of each bus transaction is readily obtained without the need to do slow cycle-by-cycle simulation. Simulation performance, hence, is significantly improved.

The compressed bus transaction model is defined as follows.

Definition 3: A compressed bus transaction model tᵢⱼ is a merged FSM of a master-slave interface pair generated from the compression algorithm, or tᵢⱼ=(mᵢ ∥ sⱼ),
where
Tᵢⱼ: the compressed bus transaction model of the pair of mᵢ and sⱼ.
Mᵢ: the i-th master interface in the bus;
Sⱼ: the j-th slave interface in the bus;
∥: compression function;

In fact, bus transactions and arbitration process are both FSMs synchronized by specific handshaking signals. Moreover, each master-slave pair bus transaction can also be divided into two phases, Request phase and Grant phase, and matches the two-phase arbiter model perfectly.

As illustrated in FIG. 4(a), if the compressed master-slave bus transaction model t₁₁ is activated, it will continue asserting the request signal (req₁!1) until it receives a grant (grant₁?1). This portion is clearly in the Request phase. After being granted, it enters the Grant phase. It then starts data transfer and after completion it sends out a finish notification (last₁) before returning to the request phase.

To focus on the arbitration process analysis for req₁, it shows in FIG. 4(b) a partial FSM of the arbiter from FIG. 2 related to req₁, grant₁ and last₁. Once the arbiter is in the Request phase, it checks if any request signal is asserted. Following assumed priority policy, when the arbiter detects that req₁ is asserted, it takes one cycle arbitration time and asserts a corresponding grant signal (grant₁!1). It then waits for the finish notification (last₁) from t₁₁ before it returns to the Request phase.

Normally the arbiter Request phase takes a fixed computation time to handle received requests. The request processing time in general can be pre-analyzed based on the combination of requests. If not, it simply computes the arbitration time in terms of cycle count (Cr) at runtime. For the fixed-priority case in FIG. 2, the request always takes arbiter one cycle time to process grant.

While in the Grant phase, the arbiter simply waits for the granted bus transaction finishing data transfer before entering next request phase. In fact, the granted master-slave pair and the arbiter are progressing synchronously and hence it can further composite the master-slave pair and the arbiter model into an optimized CMSAT model for full bus simulation. After composition, the internal handshaking signals, such as grant signal and bus transaction completion signal, between the active master-slave pair and the arbiter can be eliminated following Lo's compression algorithm. At the same time, the cycle count of grant phase (Cg) is statically calculated.

The resultant CMSAT model shown in FIG. 4(c) is the composition of the master-slave pair in FIG. 4(a) and the two-phase arbiter model in FIG. 4(b). Note that in the CMSAT model the handshaking signals, grant₁ and last₁, are eliminated and the grant phase is determined to consume three cycles, comprising one cycle for the arbiter asserting grant₁ and two cycles for bus data transfer.

The composite master-slave and arbiter transaction (CMSAT) model is formally defined in the following.

Definition 4: The composition of a compressed bus transaction tᵢⱼ and a two-phase arbiter model A is denoted as Tᵢⱼ=(tᵢⱼ ∥ A), where
Tᵢⱼ: the composite model of tᵢⱼ and A.
Tᵢⱼ: the compressed bus transaction of the pair of mi and sⱼ;
A: the two-phase arbiter model described in FSM;
∥: compression function;

Each CMSAT model represents a complete process for the arbiter granting a specific request and returning to next request phase after the granted bus transaction is finished. This optimized model eliminates unnecessary simulation overhead and hence leads to high performance simulation.

Next, it describes how to apply CMSAT models at the dynamic simulation phase.

The key for the cycle-count-accurate full bus simulation to correctly simulate contention behaviors is to maintain a correct bus transaction execution order. Then, with the CMSAT model, accurate transaction execution cycle counts are efficiently computed.

In practice, virtually all bus requests can be viewed as being stored in a request queue waiting for arbitration. After a request is granted for bus transaction, the remainders stay in the queue and the granted request will start bus transaction until completion. Furthermore, at the completion of the granted request, only the requesting master or the accessed slave (if it is also a master) may generate later new requests and affect arbitration subsequently. Hence, the master and the slave of the granted request at the completion time point can be checked and determined whether any new requests should be added into the queue.

To make the simulation process efficient, in implementation it extends the request queue to include also future requests. Nevertheless, the arbitration procedure processes only the active requests which are initiated before the arbitration starting time.

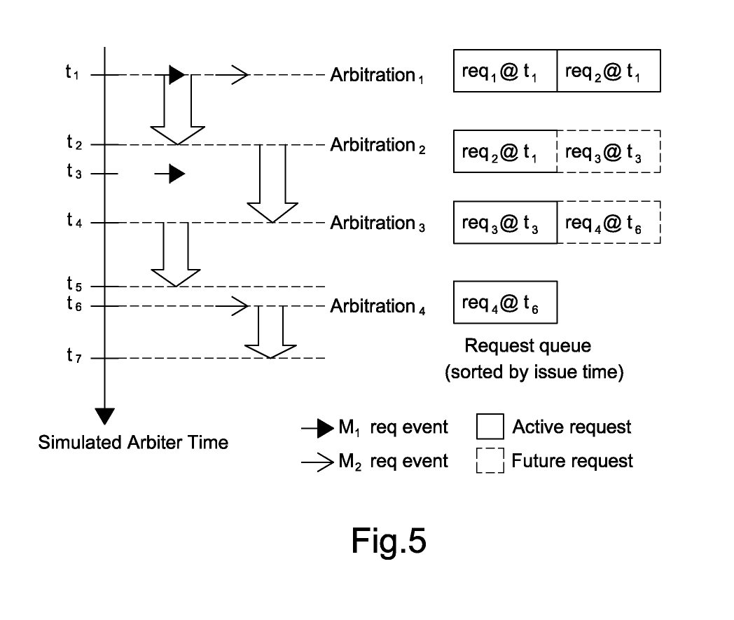

It now illustrates the present invention's algorithm using an example in FIG. 5 with the fixed-priority arbiter in FIG. 2. At first, assume that both req₁ and req₂ are simultaneously active at t₁ and are inserted into the request queue. The arbiter first advances to time t₁, the earliest time new requests occur. Then the arbiter grants req₁ according to the specified arbiter model (Arbitration₁). Consequently, the corresponding CMSAT model of req₁ is selected and then its Cᵣ and C_{g} are computed accordingly. In contrast, req₂ is still stored in the request queue since it is not granted and cannot be executed.

Subsequently, it checks if M₁ or S₁ will generate new requests at t₂, the completion time of req₁, which is activated from master M₁ to slave S₁. Suppose that a new request req₃ is generated at time t₃. Then this future request is inserted into the request queue. Now by advancing the arbiter time to t₂, the completion time of req₁, another run of arbitration process begins (Arbitration₂). At this moment, the arbiter finds that only req₂ is active in the queue and hence grants req₂ for execution.

Assume that req₂ finishes its transaction at time t₄, and then it checks if M₂ has a new request generated and find that it does generate a new request req₄ at time t₆, which is inserted into the request queue as a future request.

Now at time t₄, the arbiter starts another arbitration process (Arbitration₃) and finds that req₃ at t₃ is the only active request and hence grants req₃ for execution.

Assume that at time t₅, req₃ finishes execution and M₁ does not generate a new request. Then, when the arbiter tries to start a new run of arbitration processes, it finds that there is no active request but only one future request req₄ at t₆. Therefore, the arbiter sets the new arbitration time to t₆ and determines to grant req₄, which completes its transaction at time t₇.

The above illustrative cases cover most arbitration situations. A more general and formal full bus simulation algorithm is proposed in the following.

### Procedure Full_Bus_Simulation( )

0. Init: Generate the CMSAT models of the arbiter and all master-slave pairs.
1. Set the arbiter time to 0 and the request queue to empty. For each master, it computes the first request and inserts the request into the request queue.
2. Do until the request queue is empty.
3. If no active request in the request queue
a. Advance the arbiter time to the request time of the earliest future request.
4. Else
a. Select and grant an active request following the given arbitration policy.
b. Compute the Request phase execution time Cr of the active request.
c. Compute the Grant phase execution time Cg according to the CMSAT model of the active request.
d. Update the arbiter time by adding Cr and Cg to the current arbiter time.
e. Examine the requesting master and accessed slave of the granted request, if any of them will generate new request, push the request into the request queue.

Moreover, the present invention uses the request queue to preserve the requesting order and apply the CMSAT models to calculate accurately timing information rapidly until the request queue is empty. The present invention's approach achieves an effective full-bus simulation without need to do cycle-by-cycle simulation. Moreover, the algorithm can be implemented in POSIX pthread or common simulation engine, e.g., SystemC. Each transaction is represented as an individual process and can look ahead to determine whether new requests will be generated at the end of the transaction.

The main assumption of the proposed CMSAT model is that once a transaction enters into the Grant phase, it cannot be preempted and no other transactions on the same bus can enter the grant phase until it returns to the Request phase again.

In practice, bus preemption can still occur at the end of transaction execution. Masters such as DMA (Direct Memory Access) may request multiple transactions at a time. For this type of requests, the preempted master is designed to complete its current transaction before handing over the bus to the preempting master. This preemption case can be handled perfectly with the proposed algorithm, since the arbitration is performed at the phase boundaries.

To demonstrate the effectiveness of exploration using the proposed methodology, the present invention's modeling and simulation approach on the AMBA AXI-based bus matrix of the Parallel Architecture Core Duo (PAC-Duo) platform from ITRI are applied (please to : Z. M. Hsu, J. C. Yeh, I. Y. Chuang, “An Accurate System Architecture Refinement Methodology with Mixed Abstraction-Level Virtual Platform”, in DATA, 2010). Different combinations of architectures and arbitration policies are applied to validate exploration procedure and compare the performance and accuracy results with the CA model provided by Coware, a popular commercial tool.

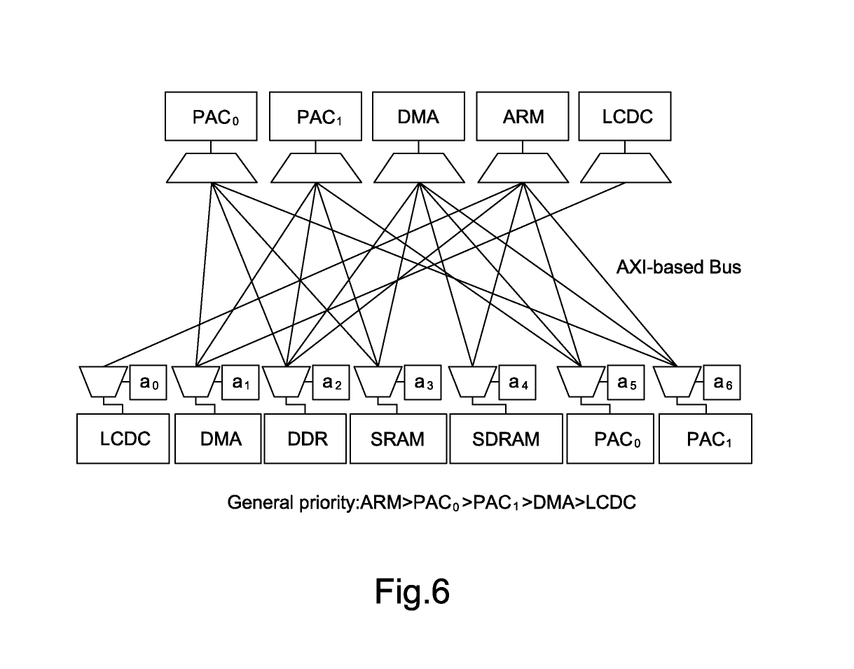

The diagram in FIG. 6 shows the PAC-Duo platform according to the proposed formal definition. It consists of two PAC DSP processors, an ARM processor, a DMA, LCDC (LCD controller), and memories. The AXI-based bus matrix of the platform is modeled through the proposed approach.

To test the effectiveness of our bus modeling approach, an H.264 decoder application with a QVGA video stream (320×240 per frame) is run on the platform. The application flow starts by having the ARM processor load H.264 decoder program from SRAM and configure the PAC DSP processors for H.264 decoder execution. The two DSP processors decode the H.264 frames in a pipeline fashion, while DMA helps with image data transfers. Whenever a frame is finished decoding, the ARM processor configures LCDC to read and display the frame.

To confirm the accuracy of the proposed approach, it may verify that the execution time points of all bus transactions generated from the proposed CMSAT model are exactly the same as that from the Coware CA AXI bus model.

For simulation performance evaluation, Table 1 lists the performance comparison in terms of the number of transactions per second. For whole platform simulation, including bus and all IPs, the proposed bus model is 5.2 times faster than the Coware CA AXI model.

TABLE 1

| | Whole platform | Communication |
|---|---|---|
| | performance/Speedup | performance/Speedup |
| Coware CA | 598/1X | 708/1X |
| CMSAT | 3121/5.2X | 16500/23X |
| Functional | 3850/6.7X | 231008/326X |
| | | (No timing information) |

In addition, results also show that the performance of our CMSAT model is almost equal to that of the purely-functional bus model, which consumes little communication time without timing information. If evaluating only on bus execution time, our CMSAT model is 23 times faster than the Coware CA model.

This huge performance improvement is mainly gained from the static analysis of CMSAT model generation. Particularly, for burst-based bus protocols, such as AXI, simulation performance is significantly improved since most simulation overhead from the data transfer and handshaking with the arbiter are eliminated by static analysis.

In the following, it demonstrates bus architecture exploration for the PAC-Duo platform. It explores the effect of arbitration policy by examining four different arbitration policies—a fixed priority policy where DMA is of higher priority than LCDC (FP₁), another fixed priority policy where LCDC is of higher priority than DMA (FP₂), a Round Robin policy with 25 cycles time slot (RR₁) and another Round Robin policy with 30 cycles time slot (RR₂).

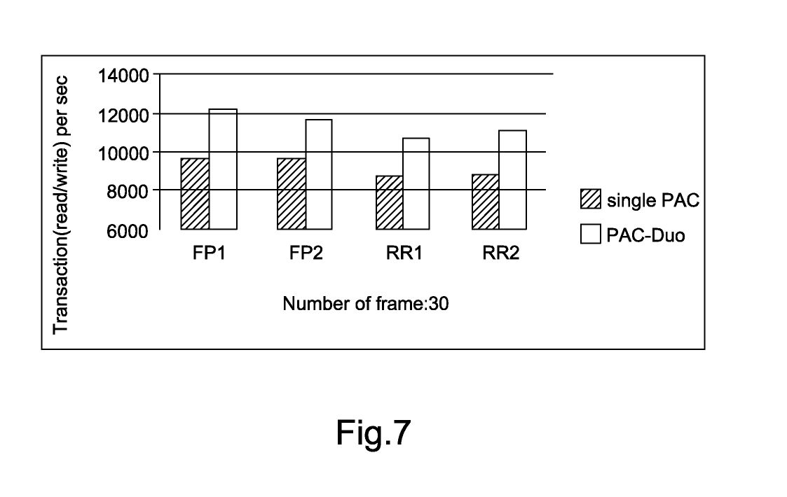

FIG. 7 shows the results of total throughputs of the platform with the above four different arbitration policies. In addition, a modified platform with only one PAC DSP is listed for reference. It is found that the PAC-Duo platform outperforms the single PAC platform, but the Duo platform is more sensitive to the choice of arbitration policy. For the PAC-Duo platform, performance can differ as much as 15% depending on the choice of arbitration policy, while for the single PAC platform the difference is only 9%. This is due to the fact that the PAC-Duo platform has a much higher contention rate because there are more active masters requesting data transfers.

Through the experiments, it has demonstrated that the proposed approach can efficiently and effectively optimize bus and system architecture design. In the present invention, it has presented a highly efficient FSM-based Composite Master-Slave pair and Arbiter Transaction (CMSAT) model for full bus simulation. Following the proposed approach, designers can easily describe bus designs and perform Cycle-count Accurate (CCA) simulation for full bus performance analysis and architecture exploration.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A method of a full bus transaction level modeling for fast and accurate contention analysis, comprising:
for each master, computing a request and inserting said request into a request queue by a processing unit until said request queue is empty;
if no active request in said request queue, advancing an arbiter time to a request time of an earliest future request;
otherwise, selecting and granting an active request based-on a given arbitration policy;
computing a request phase execution time of said active request by said processing unit;
computing a grant phase execution time of said active request by said processing unit; and
examining a requesting master and/or an accessed slave of said granted request, if any of them will generate a new request, push said new request into said request queue.

2. A method in claim 1, wherein said computing a grant phase execution time of said active request is performed according to a CMSAT model of said active request.

3. A method in claim 2, wherein said CMSAT model is that once a transaction enters into said grant phase, it cannot be preempted and no other transactions on the same bus can enter said grant phase until it returns to said request phase again.

4. A method in claim 1, further comprising updating said arbiter time by adding said request phase execution time and said grant phase execution time to a current arbiter time.

5. A method in claim 1, wherein after said request is granted for bus transaction, remainder requests stay in said queue and said granted request will start bus transaction until completion.

6. A method of a full bus transaction level modeling for fast and accurate contention analysis, comprising:
receiving bus requests from master components by an arbiter and then performing an arbitration process and granting according to a specified arbitration policy;
in a request phase, said arbiter collects all incoming request signals and computes which said master component is granted;
in a grant phase, said arbiter assigns said granted master component to have said bus for data transfer; and
sending a notification signal by a processing unit to said arbiter such that said arbiter returns to its initial state and gets ready for a next request processing.

7. A method in claim 6, wherein said performing an arbitration process is accomplished by asserting specific handshake signals.

8. A method in claim 6, further comprising modeling accessible slaves identified by memory-mapped address from said granted master component.

9. A method in claim 6, wherein each slave component has its corresponding multiplexer controlled by said arbiter, each said master component has its corresponding demultiplexer, said corresponding multiplexer is connected said corresponding demultiplexer.

10. A method in claim 6, further comprising modeling potential accessing master components.

11. A method in claim 6, wherein if no request tends to use said bus, said arbiter stays in an initial state.
